(19) United States
(12) Patent Application Publication
(10) Pub. No.: US 2026/0267676 A1
(43) Pub. Date: Sep. 10, 2026

(54) PLUGGABLE STORAGE NORMALIZATION FOR ORCHESTRATION AND MANAGEMENT OF HETEROGENEOUS COMPUTING RESOURCES

(71) Applicant: Hewlett Packard Enterprise Development LP, Spring, TX (US)

(72) Inventors: David Rabon Estes, Westfield, IN (US); Brian David Wheeler, Cherry Hills Village, CO (US)

(21) Appl. No.: 19/074,075

(22) Filed: Mar. 7, 2025

(51) Int. Cl. G06F 9/455

(52) U.S. Cl. CPC G06F 9/45558; G06F 2009/45583

(57) ABSTRACT

A system and method for pluggable normalization of storage orchestration are provided. Data from a storage system and a virtualization system is normalized into a normalized data model. A service request for creating a virtual machine and virtual disk is received. A storage provider plugin for the storage system is loaded. The virtual disk is created in the storage system using the storage provider plugin, which normalizes interactions between the normalized data model and storage system. A hypervisor-specific storage configuration is generated using the storage provider plugin, specifying parameters for attaching the virtual disk to the virtual machine. The virtual machine is created in the virtualization system using the hypervisor-specific storage configuration.

### BACKGROUND

Cloud computing has revolutionized the way organizations manage and deploy IT resources. By providing on-demand access to a shared pool of configurable computing resources, cloud platforms enable organizations to rapidly scale their infrastructure and services without needing large upfront investments in hardware. These resources can include virtual machines, storage, networking, databases, and various software applications and services.

The cloud computing model typically encompasses several service categories, including Infrastructure as a Service (IaaS), Platform as a Service (PaaS), and Software as a Service (SaaS). IaaS provides virtualized computing resources over the internet, allowing users to rent virtual machines, storage, and networking. PaaS offers a platform for developers to build, run, and manage applications without the complexity of maintaining the underlying infrastructure. SaaS delivers software applications over the internet, eliminating users needing to install and run the applications on their computers or infrastructure.

As cloud adoption has grown, many organizations have embraced hybrid and multi-cloud strategies. Hybrid cloud environments combine public and private cloud resources, allowing businesses to keep sensitive data on-premises while leveraging the scalability and cost-effectiveness of public clouds for other workloads. Multi-cloud approaches involve using services from multiple cloud providers, which can help avoid vendor lock-in and optimize for specific capabilities offered by different platforms.

The management and orchestration of resources across diverse cloud environments can present significant challenges for organizations. Various tools and platforms have emerged to address these challenges. However, the rapidly evolving nature of cloud services continues to introduce new complexities and obstacles.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of a cloud computing management environment, according to some implementations.

FIG. 2 is a block diagram of hardware components of the management platform, according to some implementations.

FIG. 3 is a block diagram of the software architecture of the management environment, according to some implementations.

FIG. 4 is a block diagram of a management method, according to some implementations.

FIG. 5 is a block diagram of the cloud computing management environment, according to some implementations.

FIG. 6 is a flowchart of a method for implementing a storage provider plugin, according to some implementations.

FIG. 7 illustrates a flowchart of a method for creating a virtual machine and virtual disk, according to some implementations.

Corresponding numerals and symbols in the different figures generally refer to corresponding parts unless otherwise indicated.

### DESCRIPTION

The following disclosure provides many different examples for implementing different features. Specific examples of components and arrangements are described below to simplify the present disclosure. These are, of course, merely examples and are not intended to be limiting.

Managing and orchestrating diverse resources presents significant challenges for organizations. One particular area of complexity lies in storage management, where an environment may use multiple different provider-specific storage systems, which may utilize distinct storage characteristics (e.g., storage protocols, programming interfaces, formats, etc.). This heterogeneity can lead to increased operational overhead, particularly when providing storage from heterogeneous storage systems to virtualization systems for virtual machines.

This disclosure describes a pluggable storage normalization system for orchestrating and managing heterogeneous storage systems, potentially across multiple cloud environments. The system employs a modular architecture that allows for seamless integration of various storage characteristics, enabling management of diverse storage systems from a unified platform. A normalized data model is used to abstract provider-specific details of different storage systems into a standardized representation, serving as a foundation for consistent management operations.

The pluggable storage normalization system utilizes storage provider plugins to interface with storage systems. These plugins encapsulate the unique storage characteristics of each storage provider, allowing the system to interact with diverse storage backends through a unified interface. When a service request for creating a virtual machine and associated virtual disk is received, the system loads the appropriate storage provider plugin for the specified storage system. This plugin then facilitates the creation of the virtual disk in the storage system, abstracting away the complexities of the underlying storage implementation.

The storage provider plugins normalize interactions between the normalized data model and the storage systems. This normalization enables consistent management operations across heterogeneous storage systems by, e.g., translating generic storage requests at the management platform into provider-specific API calls and vice versa. The plugins may be implemented using a plugin template provided by the management platform, which includes source code with predefined integration points and build tooling.

In addition to managing storage resources, the system addresses the challenges of integrating storage with virtualization platforms. The storage provider plugins may generate hypervisor-specific storage configurations, enabling seamless attachment of provider-specific storage to virtual machines. This capability allows the system to create virtual machines in a virtualization system using storage configurations optimized for specific storage backend and virtualization system combinations.

The pluggable storage normalization system handles service requests for both direct creation of virtual machines and disks, as well as orchestration of complete applications. When processing a service request, the system determines the appropriate storage provider plugin to use based on the target storage system. For application orchestration, the system may automatically create virtual machines and associated storage as part of a broader deployment process.

By providing a standardized interface for storage operations, the pluggable storage normalization system reduces the complexity of managing diverse storage systems in multi-cloud environments. This approach enables organizations to leverage capabilities of different storage providers while maintaining a consistent management paradigm through a unified platform. The system’s ability to generate hypervisor-specific storage configurations enhances compatibility across different virtualization platforms. Furthermore, the pluggable architecture allows for integration of new storage providers, enhancing the system’s adaptability to evolving cloud storage technologies.

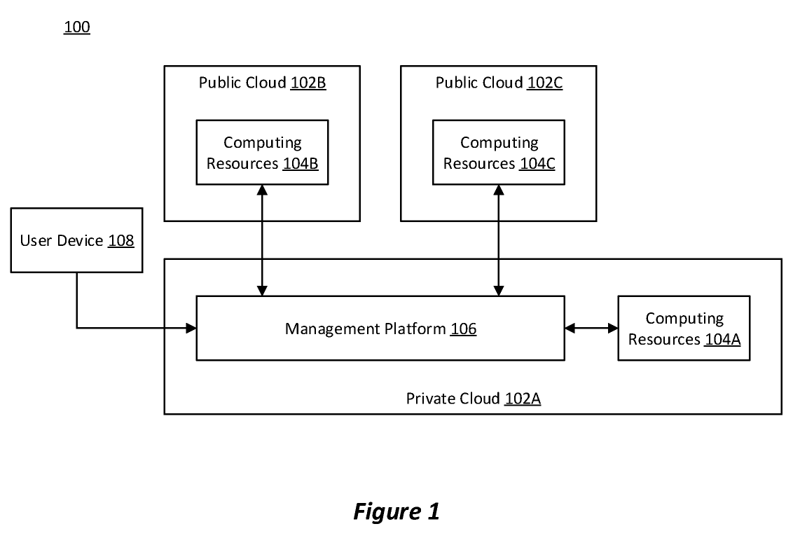

FIG. 1 is a block diagram of a cloud computing management environment 100, according to some implementations. The management environment 100 may include multiple clouds 102 (including a private cloud 102A and one or more public clouds 102B, 102C), a management platform 106, and a user device 108. This architecture represents a hybrid cloud approach for an organization, combining private and public cloud resources under centralized management while maintaining data privacy and security.

The private cloud 102A may be a privately accessible computer network under the organization’s control. In some aspects, it may provide dedicated computing resources and infrastructure that are not shared with other organizations. The private cloud 102A may offer enhanced security and customization options compared to public cloud offerings. In some cases, it may allow the organization to maintain sensitive data and critical workloads on-premises while still leveraging cloud technologies and architectures. The private cloud 102A may be managed and operated by the organization’s IT staff, providing greater control over resource allocation, security policies, and compliance measures.

The public clouds 102B, 102C may be publicly accessible computer networks operated by cloud providers. In some aspects, they may provide shared computing resources and infrastructure that can be utilized by multiple organizations. The public clouds 102B, 102C may offer organizations scalable and on-demand access to computing power, storage, and various services. In some cases, they may allow organizations to rapidly provision resources without large upfront investments in hardware and infrastructure. The public clouds 102B, 102C may be managed and operated by third-party cloud service providers, offering services and programming interfaces for resource allocation and management. In some implementations, they may provide built-in redundancy and geographic distribution of resources to enhance reliability and performance. The public clouds 102B, 102C may be operated by different service providers, allowing organizations to leverage the unique strengths and capabilities of multiple cloud platforms.

The clouds 102 include computing resources 104 (e.g., computing resources 104A, computing resources 104B, and computing resources 104C for, respectively, the private cloud 102A, the public cloud 102B, and the public cloud 102C). The computing resources 104 may include various types of resources that can be utilized to perform computational tasks, store data, and the like. In some aspects, these resources may include virtual machines, containers, serverless functions, storage volumes, databases, networking components, and other cloud-based services. The computing resources 104 may be dynamically scalable, allowing for flexible allocation based on demand. In some cases, the computing resources 104 may include specialized hardware such as GPUs for machine learning tasks or FPGAs for custom acceleration. The computing resources 104 may also encompass platform services like managed Kubernetes clusters, serverless platforms, or IoT device management systems. Additionally, the computing resources 104 may include software-defined infrastructure components that can be programmatically controlled and configured. The specific types and configurations of computing resources 104 may vary between the private cloud 102A and public clouds 102B and 102C, reflecting the different capabilities of each environment.

The management platform 106 may serve as a central control point in the management environment 100, coordinating interactions between the various components (including the computing resources 104). In some implementations, the management platform 106 may be deployed within the private cloud 102A. In other implementations, the management platform 106 may be deployed within another part of an organization. The management platform 106 may control the computing resources 104A within the private cloud 102A and the computing resources 104B, 104C in the public clouds 102B, 102C. Specifically, the management platform 106 may send instructions to and receive information from the computing resources 104, which may allow for efficient allocation and management of resources across the clouds 102.

In some cases, the hybrid architecture of the management environment 100 may enable the organization to maintain sensitive workloads and data within their private cloud 102A while leveraging the scalability and cost-effectiveness of public clouds 102B, 102C for other operations. The management platform 106 may provide a unified view of the computing resources 104, regardless of location, allowing for consistent policies and management practices across the entire environment.

The user device 108 may be connected to the management platform 106, allowing users to interact with and control the management platform 106. This may enable administrators to manage computing resources 104 across private and public clouds from a single interface, streamlining operations and reducing complexity. This may also enable end-users (e.g., non-administrators) to access computing resources 104 as permitted by their roles and permissions. Specifically, the management platform 106 may provide self-service capabilities for end-users to provision and manage resources within defined policies and limits set by administrators.

The management platform 106 may provide a unified view of resources across multiple cloud providers and on-premises infrastructure. This unified view may allow an administrator using a user device 108 to monitor and manage the computing resources 104 across the private cloud 102A and public clouds 102B, 102C from a single interface. In some aspects, the management platform 106 may aggregate data from various sources and present it in a consistent, normalized format, enabling users to easily compare and analyze resource utilization across different environments. The normalization process may involve transforming definitions for provider-specific computing resources 104 into defined schemas, creating a standardized representation of diverse resource types. This transformation may allow the management platform 106 to handle heterogeneous data from different cloud providers and on-premises systems uniformly. The defined schemas may capture the requisite attributes and relationships of resources, enabling the platform to maintain a coherent view of the entire infrastructure landscape. By normalizing the data, the management platform 106 may facilitate cross-provider comparisons, simplify resource management tasks, and provide a foundation for advanced analytics and optimization strategies.

In addition to unified visibility, the management platform 106 may offer unified control of the computing resources 104. The platform may leverage programming interfaces provided by the computing resources 104 to enable centralized management and orchestration. This unified control may allow administrators to perform actions such as provisioning, scaling, and configuring resources across multiple environments from a single point of control. The management platform 106 may abstract away the particularities of individual provider interfaces, presenting a consistent set of management operations that can be applied across heterogeneous computing resources 104. This unified control approach may streamline management and orchestration operations, including day-2 operations.

The management platform 106 may discover and inventory computing resources 104 across the clouds 102. This discovery process may involve periodic scanning and synchronization to maintain an up-to-date view of available resources. The platform may automatically detect new resources, changes to existing resources, and resource removals across both private cloud 102A and public clouds 102B, 102C. The discovered computing resources 104 may be mapped to a normalized data model (subsequently described) for the platform, enabling consistent representation regardless of the source cloud. The discovery process may capture detailed metadata about computing resources 104, including relationships between resources, configuration settings, and operational state. This comprehensive resource discovery may enable the management platform 106 to maintain an accurate inventory of infrastructure components and their dependencies across the entire management environment 100.

The management platform 106 may manage user access and authentication within the system. This functionality may allow administrators to control the resources and capabilities end-users can access through the user devices 108. The platform may implement role-based access control (RBAC) to define and manage user permissions across the entire management environment 100, ensuring that users are limited to having access to the resources and functions appropriate for their roles. In some implementations, the management platform 106 may layer a user authentication and authorization framework over existing frameworks (if any) of the computing resources 104. For example, the management platform 106 may have a master application programming interface (API) key to a computing resource 104 and may control how the computing resources 104 are accessed by users based on its own authentication and authorization system. The platform may map user identities and roles across different systems, providing a unified access model that spans heterogeneous environments. In some cases, the management platform 106 may integrate with existing authentication systems, enabling single sign-on capabilities.

The management platform 106 may implement a comprehensive security and compliance framework across the management environment 100. This framework may include automated security scanning of computing resources 104, continuous compliance monitoring, and policy enforcement during resource provisioning and management. The platform may integrate with security tools and services to perform vulnerability assessments, configuration audits, and security monitoring of resources across clouds 102. In some implementations, the management platform 106 may enforce security policies during provisioning, automatically configuring security controls and validating compliance requirements as resources are deployed. The platform may maintain audit trails of actions performed on computing resources 104, enabling organizations to track changes and demonstrate compliance with security requirements. Security policies may be defined and enforced consistently across the private cloud 102A and the public clouds 102B, 102C, ensuring uniform security controls regardless of resource location.

The management platform 106 may provide self-service capabilities to users of the user device 108. An end-user may request and provision resources through a user device 108 within predefined limits and policies set by administrators. In some aspects, the management platform 106 may present different interfaces or options to users based on their roles or permissions, allowing for customized self-service experiences while ensuring compliance with organizational policies. The self-service capabilities may be constrained by configuration settings defined within the management platform 106 by the organization. For example, administrators may set resource quotas, cost thresholds, or approved computing resources 104 that limit what end-users can provision. The management platform 106 may enforce these constraints automatically when processing self-service requests. Additionally, the management platform 106 may provide approval workflows for certain requests requiring additional authorization before provisioning. This allows organizations to enable user-driven provisioning while maintaining appropriate governance and control over resource usage. The platform may support contextually aware deployments, considering user permissions and group participation when determining where and how to provision resources.

The management platform 106 may implement an application-centric approach to resource management, allowing for the orchestration of complete application stacks rather than individual infrastructure components. This approach may allow users to request and manage entire applications, with the platform automatically determining and provisioning suitable computing resources 104 for the application across appropriate clouds 102, as specified by organizational policies and system configurations. The management platform 106 may maintain application context throughout the resource lifecycle, understanding relationships between application components and their supporting infrastructure. In some implementations, the management platform 106 may provide application-level monitoring, scaling, and lifecycle management capabilities. This application-centric model may abstract away infrastructure complexity, allowing users to focus on orchestrating and managing applications while the platform handles the orchestration of underlying resources and day-2 aspects. The management platform 106 may track application dependencies and requirements, using this information to make intelligent decisions about resource placement and configuration across the private cloud 102A and public clouds 102B, 102C.

The management platform 106 may provide streamlined lifecycle management of applications, from initial deployment through scaling and updates. This may include capabilities for monitoring application performance, automating scaling operations, and managing updates or patches. Users may be able to manage the entire application lifecycle through a user device 108, with the management platform 106 coordinating the requisite actions across the relevant computing resources 104 in the private cloud 102A or public clouds 102B and 102C.

The management platform 106 may integrate with various external tools and services that support the computing resources 104. These integrations may include IP address management (IPAM) systems for network address allocation, load balancers for traffic distribution, monitoring tools for performance tracking, backup systems for data protection, security scanners for vulnerability detection, domain name system (DNS) providers for name resolution, and the like. The management platform 106 may coordinate with these external tools and services during orchestration and management. For example, when configuring a computing resource 104 as part of an application’s orchestration, the management platform 106 may interact with an IPAM system to allocate an IP address, a DNS provider to register a hostname, and a load balancer to configure traffic routing. The platform may maintain associations between computing resources 104 and related external services throughout the resource lifecycle, ensuring proper cleanup and resource release when resources are decommissioned. These integrations may be configured at the organization level and may apply across resources in both the private cloud 102A and public clouds 102B, 102C.

The management platform 106 may provide capabilities for tracking and metering resource usage to enable cost management and optimization. This may involve collecting detailed usage data from the computing resources 104 across the clouds 102 and presenting it in a unified format. The platform may aggregate costs and bills from the various computing resources 104 to provide consolidated financial reporting. In some aspects, the management platform 106 may implement FinOps practices to align technology spending (on the computing resources 104) with policies of the organization. Users may access this data through a user device 108, gaining improved visibility into resource utilization and dependencies across the entire IT landscape. The management platform 106 may provide user interfaces for analyzing this data, helping users identify opportunities for cost optimization or efficiency improvements. In some cases, the platform may enable chargeback or showback reporting to allocate costs to specific business units or projects.

The management platform 106 may provide a comprehensive, provider-agnostic API that enables users to script and automate operations across heterogeneous cloud environments. This API may abstract away the differences between various cloud providers and on-premises systems, presenting a unified interface for managing computing resources 104 regardless of their location or underlying technology. Through this API, users can programmatically control aspects of resource provisioning, configuration, and lifecycle management across the private cloud 102A and public clouds 102B, 102C using consistent commands and data structures. In some implementations, the API may support various programming languages and offer client libraries to facilitate integration with existing tools and workflows. The provider-agnostic nature of the API may allow organizations to develop portable automation scripts and tools that can operate across different cloud environments without modification, reducing vendor lock-in and enhancing flexibility in multi-cloud strategies. These programmatic interfaces may enable advanced automation scenarios, support infrastructure-as-code practices, and facilitate integration with continuous integration and continuous delivery pipelines as well as other DevOps tools.

The management platform 106 may normalize data from heterogeneous sources into a common data model. Example sources of data may include data from computing resources 104 across the clouds 102, financial systems, management tools, and the like. This normalization may enable the management platform 106 to orchestrate workflows that span multiple environments and domains, considering the unique characteristics and capabilities of each resource type.

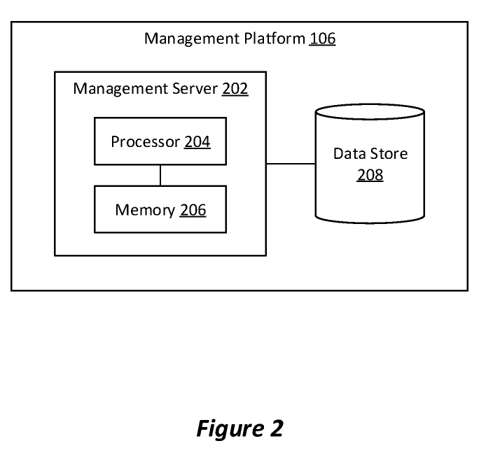

FIG. 2 is a block diagram of hardware components of the management platform 106, according to some implementations. The management platform 106 may include one or more management servers 202 and one or more data stores 208. Only one management server 202 and data store 208 are shown in this example.

In some aspects, the management server 202 may serve as a central component of the management platform 106, performing administrative functions. These functions may include managing and/or orchestrating provider-specific computing resources, normalizing heterogeneous data, processing service requests, and the like.

The management server 202 may include suitable components for performing any desired functionality. One or more modules within the server may be partially or wholly embodied as software and/or hardware for performing any functionality described herein. For example, a server may include a processor 204 and a memory 206. The processor 204 may be a microprocessor, an application-specific integrated circuit, a microcontroller, or the like. The memory 206 may be a non-transitory computer-readable medium that stores instructions for execution by the processor 204. The instructions, when executed by the processor 204, may cause the processor 204 to perform any functionality described herein.

The data store 208 may provide storage capacity for maintaining data related to the managed resources and services. In some aspects, the data store 208 may include database servers, file servers, network-attached storage (NAS) devices, or the like for storing the normalized data representing heterogeneous provider-specific computing resources. The data store 208 may be implemented using various storage technologies, such as relational databases, NoSQL data stores, distributed file systems, object storage, block storage, or the like depending on the specific requirements of the management platform 106.

In some cases, the management platform 106 may include redundant components or distributed architectures to provide high availability and fault tolerance. For example, the management server 202 may be implemented as a cluster of servers, with the workload distributed across multiple physical or virtual hosts. Likewise, the data store 208 may be implemented using a distributed database system to achieve data redundancy and availability. The management platform 106 may also incorporate load balancing mechanisms to distribute incoming requests across multiple servers.

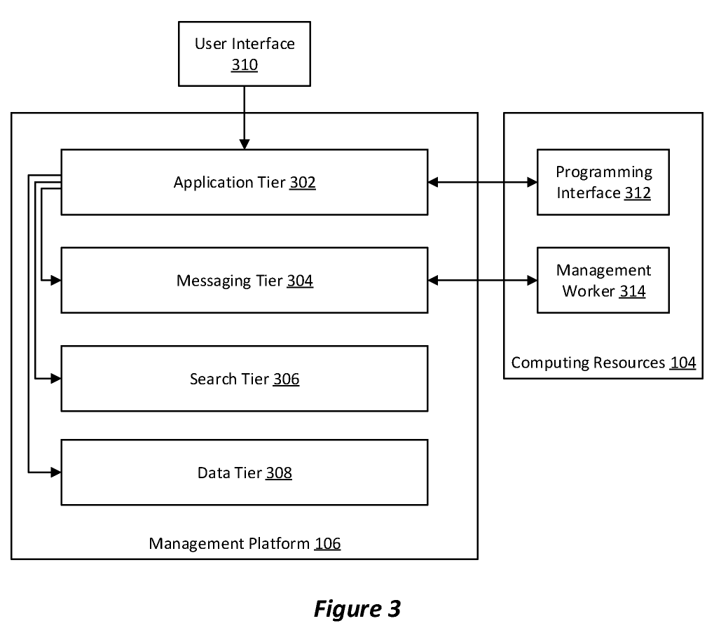

FIG. 3 is a block diagram of the software architecture of the management environment 100, according to some implementations. The diagram illustrates the various software components and tiers that make up the management platform 106 and the computing resources 104.

The management platform 106 may be implemented using a tiered architecture to organize its functionality. This architecture may include an application tier 302, a messaging tier 304, a search tier 306, and a data tier 308. The management platform 106 may include more or fewer tiers than shown in this example. The specific number and organization of tiers may vary depending on the requirements and design choices of the system.

The application tier 302 may form the core of the management platform 106, handling the primary business logic and orchestration tasks. The application tier 302 may control the other tiers within the management platform 106: the messaging tier 304, the search tier 306, and the data tier 308. In some aspects, the application tier 302 may include software applications for processing service requests, orchestrating resources, managing workflows, and the like. The application tier 302 may interact with external computing resources 104 and may coordinate activities across different cloud environments. In some implementations, the application tier 302 may be built using a microservices architecture, allowing for scalability and flexibility. The application tier 302 may leverage data stored in the data tier 308 (e.g., using a normalized data model) to make intelligent decisions about resource allocation and configuration. In some implementations, the application tier 302 may run nginx for serving a web interface, Apache Tomcat for handling business logic, and Apache Guacamole for providing remote access and control capabilities. Other applications may run in the application tier 302.

The messaging tier 304 may facilitate communication between different components of the management platform 106 and external systems. The messaging tier 304 may implement a publish-subscribe model or utilize protocols such as Advanced Message Queuing Protocol (AMQP), running a message broker like RabbitMQ, to provide reliable and asynchronous communication between various components of the management platform 106 and computing resources 104. In some aspects, the messaging tier 304 may include a load balancer that receives messages from the application tier 302 and distributes them to message brokers.

The search tier 306 may provide indexing and search capabilities for the management platform 106. This tier may enable efficient querying and retrieval of information across the normalized data model stored in the data tier 308. In some implementations, the search tier 306 may utilize a non-transactional database such as Elasticsearch to provide high-performance full-text search and analytics capabilities. The use of Elasticsearch or similar technologies may allow for rapid searching and aggregation of large volumes of data from heterogeneous sources. This search functionality may support various operations within the management platform 106, such as resource discovery, monitoring, and reporting. The search tier 306 may index data from multiple sources, including the normalized data model, logs, and metrics, to provide a unified search interface across the entire management environment.

The data tier 308 may be responsible for data storage and management within the management platform 106. This tier may implement a normalized data model that represents the heterogeneous provider-specific computing resources in a standardized format. In some aspects, the data tier 308 may utilize a transactional database (such as MySQL, PostgreSQL, or the like) to store and manage the normalized data. Using a transactional database may provide Atomicity, Consistency, Isolation, and Durability (ACID) properties, ensuring data integrity and reliability. This may be particularly important when dealing with complex relationships and dependencies between heterogeneous resources. The data tier 308 may handle database operations such as inserting, updating, and querying the normalized data, providing a consistent and reliable data layer for the other tiers of the management platform 106.

The management platform 106 may provide a user interface 310, serving as the entry point for user interactions with the system. The user interface 310 may connect directly to the application tier 302, allowing users to initiate management and orchestration tasks, view resource status, and access other platform features.

A computing resource 104 may implement various mechanisms for interacting with the management platform 106. A programming interface 312 may provide programmatic access to the platform’s functionality. The programming interface 312 may represent an API provided by a cloud provider, enabling the management platform 106 to interact with and control resources in that provider’s environment. When the management platform 106 interacts with the computing resources 104 via a programming interface 312, the application tier 302 may directly access the programming interface 312, such as via web API requests.

A management worker 314 may be executed in the computing resources 104 and may interact with the management platform 106 through messaging. The management worker 314 may be a custom application executing in the cloud provider’s environment. In some aspects, the management worker 314 may be a system process running on a computing device (e.g., a physical or virtual host). In some aspects, the management worker 314 may process tasks or messages and facilitate interactions between the management platform 106 and the specific cloud environment by sending information to the management platform 106. For example, the management platform 106 may interact with the computing resources 104 by sending messages to the management worker 314 via the messaging tier 304.

In some implementations, the management worker 314 may act as an intermediary between the management platform 106 and agents running on the computing resources 104. The management worker 314 may perform certain tasks as delegated thereto by the management platform 106. For instance, the management worker 314 may collect data from the computing resources 104 and return it to the management platform 106. The management worker 314 may also orchestrate components of the computing resources 104 based on instructions received from the management platform 106.

The management worker 314 may aggregate and multiplex communications from multiple agents running on computing resources 104 within a provider. This may potentially reduce the number of network connections to the management platform 106 from the provider. In some cases, the management worker 314 may facilitate remote host console access to the agents in the computing resources 104, act as a proxy for cloud provider APIs, and dynamically execute plugin code to perform local processing and optimization. This approach may allow organizations to manage resources across multi-cloud environments more efficiently, while maintaining security and potentially reducing network overhead.

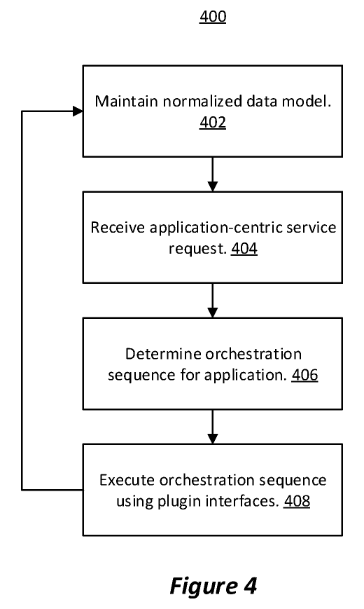

FIG. 4 is a block diagram of a management method 400, according to some implementations. The management method 400 will be described in conjunction with the management environment 100 of FIGS. 1-3. The management method 400 may be used for managing and orchestrating heterogeneous cloud resources through a normalized data model. The management method 400 may be implemented in the management environment 100. Specifically, the management platform 106 may perform the management method 400.

At step 402, the management platform 106 maintains a normalized data model of heterogeneous data from the provider-specific computing resources 104. The normalized data model may be built by obtaining heterogeneous data from various providers, which data is then normalized into the normalized data model. For example, the management platform 106 may perform data normalization in the application tier 302. In some implementations, the normalizing of the heterogeneous data is performed by the management platform 106. The normalization process transforms diverse definitions of computing resources 104 into defined schemas representing relationships and dependencies across different computing resources 104, regardless of origin. Thus, the management platform 106 has a common format for describing and managing computing resources 104 from any provider.

For example, the normalization process can include converting various configurations (of virtual machines, IP address managers, etc.) into common formats that generically represent the configurations. For example, the management platform 106 may convert VMware-specific virtual machine attributes, AWS-specific instance properties, or InfoBlox IPAM configurations into their respective common representation. In the case of resource allocation, what may be called a resource pool in VMware, a VPC in Amazon, or a resource group in Azure, can be normalized into a common representation in the data model. The normalization may preserve provider-specific features while maintaining common denominator functionality across providers. Continuing the previous example, configurations of an IP address management tool like InfoBlox can be normalized such that network resources work seamlessly with network configurations from various cloud providers without requiring custom integration code for each combination.

The normalized model maintains relationships between components while preserving provider-specific capabilities, enabling cross-service interactions through common data abstractions. The model tracks relationships between applications and supporting infrastructure, enabling services that don’t natively know about each other to interact through the normalized data model. The normalization allows the system to represent, for example, a virtual machine and a container in a common format, facilitating the management of resources across different technological paradigms through a common abstraction layer.

The normalized data model is stored in a database. For example, the management platform 106 may store the normalized data in the data tier 308. The stored model captures resource relationships, dependencies, and configurations in a format that can be efficiently queried and updated by the application tier 302. The data tier 308 may leverage a transactional database to maintain data integrity across the normalized representations. The transactional database schema includes tables that normalize infrastructure components and their relationships in the management environment. For example, a virtual machine may be represented in one table and the virtual machine’s network card may be represented in another table, with the network card’s IP address and connected switch tied off in related tables through the normalized data model. The structure tracks relationships and dependencies across heterogeneous resources while maintaining data consistency.

The data tier 308 interacts with the application tier 302 through database operations for storing and retrieving normalized data. The messaging tier 304 coordinates communication between the data tier 308 and other components through, for example, message queues, enabling asynchronous data operations. The search tier 306 may utilize a non-transactional database, such as Elasticsearch, to index the normalized data, enabling high-performance searching and aggregation across the normalized model.

The search tier 306 provides indexing and search capabilities across the normalized data model stored in the data tier 308. This enables efficient querying and retrieval of information about resources, relationships, and configurations stored in the data tier 308. The search functionality, provided by the search tier 306, supports various operations within the management platform 106, such as resource discovery, monitoring, and reporting.

The heterogeneous data may be collected by the management platform 106 through various approaches. In some cases, the application tier 302 may directly interact with the programming interface 312 of the computing resources 104 to gather data. This approach may involve making API calls to cloud provider services or on-premises systems to retrieve information about resource configurations, states, and relationships. Alternatively, the messaging tier 304 may collect data by communicating with the management worker 314 deployed within the computing resources 104.

The management worker 314 may aggregate data from multiple agents or resources within its environment and send this information to the messaging tier 304 using a messaging protocol. In some implementations, the management worker 314 may directly interact with resources that do not have a programming interface 312 usable by the application tier 302. For example, the management worker 314 may use provider-specific libraries or classes, from a provider-specific Software Development Kit (SDK), to communicate with resources and collect data, then relay that information back to the management platform 106 for normalization and storage. Additionally or alternatively, the management worker 314 may interact with the programming interface 312 (when available) of a resource. The combination of these approaches may allow the management platform 106 to gather comprehensive data about heterogeneous resources across diverse environments, even when those resources are legacy components that may not offer a programming interface usable by the management platform 106.

At step 404, a service request for application deployment is received through, for example, a user interface or programming interface. In some aspects, the management platform 106 may provide self-service capabilities, allowing end-users to request and provision applications. The application tier 302 may receive the service request through the user interface 310. The service request may specify application requirements that span multiple provider-specific computing resources. Using the normalized data model maintained at step 402, the management platform 106 can process the application deployment request based on the request’s context, such as whether the request comes from a QA department or production environment.

Thus, the management platform 106 implements an application-centric approach to resource management, allowing for the self-service orchestration of complete application stacks rather than individual infrastructure components. This approach allows end-users to request and manage entire applications, with the platform automatically determining and provisioning suitable computing resources for the application across appropriate clouds, as specified by organizational policies and system configurations. For example, a service request may request deployment of a multi-tier application. Based on the normalized data model, organization policies, and configurations, the management platform 106 may determine requisite compute resources to deploy the requested application. For example, the management platform 106 may form an orchestration plan that specifies compute resources from VMware, a network configuration via InfoBlox, and a load balancer configuration. In another example, a request may specify deploying a WordPress application, which requires the management platform 106 to identify and coordinate components, including web servers, database servers, storage, and network configurations. When deploying a web application, the request may specify requirements for a web server and a database server, where the database server is to be provisioned before the web server due to dependency requirements. The normalized data model enables the management platform 106 to deploy components in a way that makes them work together even though they don’t natively know about each other.

At step 406, the management platform 106 determines an orchestration sequence to handle the service request. The requests are processed through the normalized data model to identify the requisite resources and dependencies. The normalized model enables the management platform 106 to understand the requisite individual resources and their relationships and dependencies across different providers. Organization policies and the end-user’s request context may also influence orchestration.

The management platform 106 determines resource placement and configuration based on the application context and organizational policies. For example, the same application service request might result in different resource allocations and configurations depending on whether it’s for development, testing, or production use. This may include deploying to specific cloud providers or resource pools based on the requesting group’s role or applying different backup, monitoring, and security policies based on the deployment context. For example, when a QA team requests a testing environment, the management platform 106 may deploy resources to a lower-cost environment with different performance characteristics than a production deployment request from an operations team. The normalized data model allows contextual deployment by enabling different orchestration workflows to be seamlessly created and executed for each deployment environment or context transparently to the end-user.

The normalized data model enables the platform to maintain contextual differences using the same underlying resource definitions and relationships. In some aspects, the normalized model may transform complex orchestration processes into automated workflows. What traditionally requires multiple teams and extended timeframes can potentially be orchestrated as an automated sequence completed in minutes through the management platform 106.

At step 408, the management platform 106 executes the orchestration sequence. The orchestration may leverage the messaging tier 304 to coordinate actions across distributed resources. The normalized data model can enable the management platform 106 to sequence operations, such as allocating IP addresses before configuring network interfaces or deploying database instances before web servers. The orchestration process may include configuring day-2 operations such as backups, compliance automation, and security scan schedules.

The management platform 106 may utilize programming interfaces 312 and/or a management worker 314 within the computing resources 104 to orchestrate provider-specific computing resources in manners expected by each provider. In some implementations, a management worker 314 may receive commands from the management platform 106 through the messaging tier 304 to execute provider-specific operations. When provisioning resources, the management worker 314 may create a secure connection back to the management platform 106 and establish a command bus for coordinating actions between the platform and provider environments. The management worker 314 can operate behind load balancers for scalability and to process cloud API requests from remote locations. The management worker 314 may interact with computing resources 104 using provider-specific libraries or through the programming interface 312, allowing for flexible integration with various cloud environments and legacy systems. In some implementations, the management platform 106 may directly orchestrate resources via the programming interfaces 312 (when available) instead of using a management worker 314.

The management platform 106 utilizes a plugin architecture that generates plugin interfaces for service providers. The plugin architecture may create code templates with predefined integration points, allowing providers or end-users to implement their specific functionality while maintaining consistent interaction with the normalized data model. For example, an end-user may integrate an IPAM with the management platform 106 by creating a plugin for the IPAM. To create the plugin, the system can generate a code skeleton with defined methods that the provider fills in to allocate resources (e.g., IP addresses) or perform other specific operations. The orchestration sequence may be performed using the plugin interfaces.

The plugins are loaded at runtime through an isolated class loader, e.g., within a Java Virtual Machine running in the application tier 302. Each plugin implements common interfaces that are clearly defined through system documentation. The management platform 106 provides a context that allows plugins to call back into the platform and save data from computing resources 104 in the normalized format.

The database schema within the data tier 308 may support the plugin architecture by providing standardized ways to store and retrieve normalized data. When plugins interact with the management platform 106, they can store their data in the normalized format through defined interfaces, allowing the data to be used consistently across the platform regardless of the original provider format.

The plugin architecture enables runtime extension of computing resources 104 integration without modifying the core code of the management platform 106. Developers can use the generated plugin code templates when integrating new providers rather than writing custom integration code. The plugin framework handles the communication and data transformation between the provider-specific implementations (of the computing resources 104) and the normalized data model, allowing new integrations to leverage existing abstractions of the management platform 106.

The management platform 106 may orchestrate provider-specific computing resources by leveraging the normalized data model and plugin interfaces. During orchestration, the platform may invoke relevant plugins to interact with specific provider programming interfaces or services. These plugins may translate orchestration commands from the normalized model into provider-specific API calls, allowing the management platform 106 to manage diverse resources through a unified programming interface. For example, when allocating storage, a plugin for a particular cloud provider may convert a generic storage request into the appropriate API calls for that provider’s block storage service. The plugin architecture may allow the orchestration process to seamlessly integrate new providers and resource types without modifying the core orchestration logic, enhancing the platform’s extensibility and adaptability to evolving cloud ecosystems.

The management platform 106 runs code from the plugins that interfaces with provider-specific programming interfaces (e.g., VMware, InfoBlox, etc.) of the computing resources 104. At the same time, the normalized data model in the data tier 308 maintains the standardized representation of the operations. For example, a management worker 314 may execute provider-specific API calls to InfoBlox when allocating an IP address. However, the results of those API calls are transformed and stored in the normalized model, enabling other components to interact with that IP address assignment without understanding InfoBlox-specific implementations.

The orchestration process can adjust its flow based on each step’s outcomes. For instance, if a call to a third-party policy API indicates additional requirements that call for extra steps in the orchestration process, the management platform 106 can inject the additional steps into the orchestration workflow. Each step in the orchestration flow has the capability of affecting subsequent steps, allowing for dynamic adaptation based on runtime conditions.

For application lifecycle management, the orchestration by the management platform 106 may include deploying various components and configuring day-2 operations. This may include deploying application code, obtaining an IP address, configuring monitoring systems, and setting up load balancer automation. When the application instance is decommissioned at the end of its lifecycle, the orchestration achieves proper cleanup, such as releasing the IP address for reuse. Throughout the application lifecycle, the process leverages the normalized data model to coordinate actions across different service providers while maintaining consistency through standardized interfaces. The management platform 106 handles both aspects of orchestration, including initial deployment and eventual teardown, providing comprehensive lifecycle management for applications across heterogeneous environments. The orchestration process through the normalized data model may transform what traditionally requires multiple teams and extended timeframes into an automated sequence of operations that may be provided in a self-service manner to end-users.

Following the orchestration operations, the normalized data model may be updated to reflect changes implemented during orchestration. In implementations, the data tier 308 performs the updating operation. For example, when an IP address is allocated during orchestration, the normalized model is updated to reflect this IP address allocation and its relationships to other resources. The updates maintain the accuracy of resource states, relationships, and configurations across the heterogeneous environment.

The search tier 306 may index the updates to enable efficient querying of the current environment. The indexing allows the management platform 106 to discover and monitor the environment, synchronizing changes to maintain an accurate inventory of infrastructure components and their dependencies. The management platform 106 can discover existing resources in the cloud and continue synchronizing any changes on a near real-time basis for provisioned resources.

The updated model can provide a foundation for subsequent orchestration operations, ensuring decisions are based on the current infrastructure state. For example, when an application instance is later modified or removed, the management platform 106 can use the updated model to understand related components that need to be reconfigured or cleaned up, such as releasing IP addresses or updating load balancer configurations. The discovery process can include monitoring installed software packages, which can be used for security scanning and compliance verification.

Maintaining, orchestrating, and updating the normalized data model establishes a continuous feedback loop where the model evolves with the infrastructure. This enables the management platform 106 to maintain consistency across heterogeneous resources while supporting complex orchestration scenarios. The normalized model allows provider-specific computing resources to interact through common interfaces while preserving their unique capabilities and requirements.

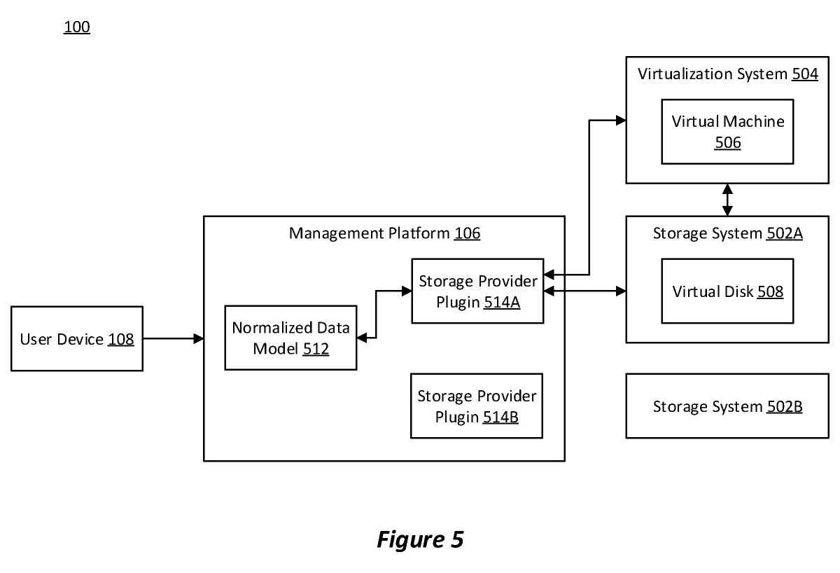

FIG. 5 is a block diagram of the cloud computing management environment 100, according to some implementations. In particular, FIG. 5 illustrates a storage provider plugin architecture for managing heterogeneous storage systems in virtualized environments. The management environment 100 may include one or more storage systems 502 and a virtualization system 504 (which may be examples of the provider-specific computing resources 104 previously described for FIG. 1), as well as the management platform 106 and a user device 108.

The storage systems 502 (including, e.g., a storage system 502A and a storage system 502B) may represent different types of storage backends used in cloud computing environments. In some cases, each storage system 502 may be a provider-specific storage system, such as a storage array from a particular vendor. The storage systems 502 may represent different types of storage backends, such as storage area networks (SANs), network-attached storage (NAS) devices, object storage systems, distributed file systems, software-defined storage solutions, cloud storage services, or the like. Each type of storage system 502 may have its own storage characteristics (e.g., storage protocols, programming interfaces, formats, etc.) for provisioning and managing storage resources. The storage systems 502 may include various hardware implementations like all-flash arrays, hybrid arrays combining solid-state drives and hard disk drives, scale-out storage clusters, or hyperconverged infrastructure appliances. Some storage systems 502 may offer advanced features such as data deduplication, compression, thin provisioning, snapshots, replication, and tiering. The storage systems 502 may be designed for specific workloads or use cases, such as high-performance databases, virtual machine storage, or long-term data archiving. Additionally, the storage systems 502 may support different storage protocols like iSCSI, Fibre Channel, NFS, SMB, or object storage protocols, allowing flexibility in how applications and virtual machines access storage resources.

The virtualization system 504 may be responsible for creating and managing virtual machines within virtualization hosts. In some cases, each virtualization system 504 may be a provider-specific virtualization system, including hypervisors, control planes, virtual networking components, and other management layers. The virtualization system 504 may include hypervisors from particular vendors, which can be type-1 hypervisors running directly on hardware, type-2 hypervisors running on top of an operating system, or the like. These hypervisors may provide core virtualization capabilities, allowing multiple virtual machines to share the same physical hardware resources of the virtualization hosts. For example, the virtualization system 504 may utilize technologies like Kernel-based Virtual Machine (KVM), which allows an operating system’s kernel to function as a hypervisor, enabling a virtualization host machine to run multiple isolated virtual environments. Additionally, the virtualization system 504 may incorporate control plane software that manages multiple hypervisors, orchestrates resource allocation, and provides centralized management interfaces. Virtual networking components within the virtualization system 504 may enable the creation and management of networks, facilitating communication between virtual machines and external networks. Each virtual machine hosted by the virtualization system 504 may have private virtualized hardware, such as network cards, graphics adapters, and virtual disks.

A virtual machine 506 may be configured in the virtualization system 504 by the management platform 106. The virtual machine 506 may be an emulation of a computer system, providing a complete system platform that supports the execution of an operating system and applications. In some implementations, the virtual machine 506 may be created based on user requests or as part of an application deployment process orchestrated by the management platform 106. The virtual machine 506 may be configured using a configuration file (such as an XML file), which may be provided by the management platform 106. The configuration file may specify details such as the virtual hardware configuration, networking settings, storage attachments, and other parameters for the virtual machine 506. The management platform 106 may generate these configuration files based on the specific requirements of the virtualization system 504 and storage system 502.

A virtual disk 508 for the virtual machine 506 may be established in a storage system 502 by the management platform 106. The virtual disk 508 may include one or more files that emulate a physical disk drive for utilization by the virtual machine 506. The virtual disk 508 may be created in a selected storage system 502 based on the requirements of the virtual machine 506 and policies defined in the management platform 106. The virtual disk 508 may provide storage capacity, performance characteristics, and other attributes as specified when creating the virtual machine 506. The management platform 106 may coordinate the provisioning of the virtual disk 508 in a storage system 502 and its attachment to the virtual machine 506 to ensure proper configuration and accessibility. In this example, the virtual machine 506 is configured to utilize a virtual disk 508 that has been set up in storage system 502A.

The virtual disk 508 allows the virtual machine 506 to store and access data as if it were using a physical hard drive, while the data is actually stored on the underlying storage system 502. Virtual disks provide flexibility in allocating storage resources to virtual machines. The size of a virtual disk can be dynamically increased as needed without shutting down the virtual machine. Virtual disks also enable features like snapshots, which capture the state of a virtual machine’s storage at a point in time. Additionally, virtual disks support other operations such as cloning, which creates an exact copy of a virtual disk, and thin provisioning, which allocates storage space on-demand rather than pre-allocating the full disk size. Virtual disks can also be migrated between different storage systems 502 or virtualization hosts while the virtual machine remains running, enabling seamless storage maintenance and upgrades.

A normalized data model 512 may be created and maintained by the management platform 106.The normalized data model 512 may provide a standardized representation of storage resources and operations across different storage systems 502. In some cases, the normalized data model 512 may abstract away the provider-specific details of each storage system 502, allowing the management platform 106 to interact with heterogeneous storage backends through a unified interface. This establishes a common language for representing storage resources and operations, regardless of the underlying storage system 502.

The standardized representation provided by the normalized data model 512 encompasses a wide range of storage-related concepts, including but not limited to volume creation, snapshot management, cloning operations, and performance metrics. By mapping provider-specific attributes and operations to this standardized model, the management platform 106 can perform consistent operations across different storage systems 502 without needing to understand the intricacies of each system’s proprietary programming interfaces or protocols. For example, when creating a virtual disk 508, the normalized data model 512 might define a standard set of attributes such as size, performance tier, and replication settings. These standardized attributes can then be translated by an appropriate storage provider plugin (subsequently described) into the specific programming interface calls or configuration parameters that are suitable for the target storage system 502. This abstraction simplifies the management of heterogeneous storage environments and also enhances the platform’s extensibility, allowing new storage systems to be integrated with minimal changes to the core management logic.

Storage provider plugins 514 (including, e.g., a storage provider plugin 514A and a storage provider plugin 514B for, respectively, the storage system 502A and the storage system 502B) may be provided to the management platform 106. These plugins may be provided by vendors, created and installed by users, or the like. To facilitate the creation of these plugins, the management platform 106 may provide a plugin template to users (e.g., the user device 108) or vendors. This template may include source code with predefined integration points and build tooling. The plugin developer can then implement the required functionality using this template, compile it, and provide the resulting binary executable to the management platform 106.

The storage provider plugins 514 normalize interactions between the normalized data model 512 and the storage systems 502. That is, the storage provider plugins 514 may serve as intermediaries between the management platform 106 and the storage systems 502. In some cases, each storage provider plugin 514 may be designed to interface with a specific type of storage system 502, translating between the normalized data model 512 and the provider-specific programming interfaces and protocols of the storage system 502. For instance, the storage provider plugin 514A may implement methods for creating, modifying, deleting, cloning, resizing, and managing snapshots of virtual disks in the storage system 502A using programming interfaces and protocols specific to that system. Similarly, the storage provider plugin 514B may be tailored to work with the particular programming interfaces and protocols of storage system 502B. This allows the management platform 106 to interact with diverse storage backends through a unified interface while preserving the capabilities of each storage system 502.

The storage provider plugins 514 enable the management platform 106 to interact with different storage systems 502 through a consistent interface. When the management platform 106 receives a request from the user device 108 to create a virtual machine 506 and associated virtual disk 508, the platform may determine an appropriate storage system 502 to use based on policies and requirements (potentially specified in the normalized data model 512). The management platform 106 may select a particular storage provider plugin 514 based on the type of the selected storage system 502. The management platform 106 may then load the corresponding storage provider plugin 514 for that storage system 502 and use it to create the virtual machine 506 and virtual disk 508. The storage provider plugin 514 facilitates the translation between the normalized data model 512 and the provider-specific programming interfaces and protocols of the target storage system 502. This translation process may involve mapping normalized parameters to provider-specific parameters, handling authentication, and managing any unique requirements of the particular storage system 502.

For example, if the virtual disk 508 is to be created in the storage system 502A, the management platform 106 may load the storage provider plugin 514A. The storage provider plugin 514A may implement methods for creating, modifying, and deleting virtual disks in the storage system 502A. These methods may be invoked by the management platform 106 using a standardized interface with data from the normalized data model 512. While the storage provider plugins 514 all implement the same standardized interface, the underlying methods implemented by each storage provider plugin 514 may differ based on the specific requirements and programming interfaces of their corresponding storage systems 502. This allows the management platform 106 to interact with diverse storage backends through a unified interface while preserving the capabilities of each storage system.

Once the virtual disk 508 has been created, the management platform 106 may generate a hypervisor-specific storage configuration for the virtual machine 506. This configuration may specify how the virtualization system 504 should connect to and use the virtual disk 508 when running the virtual machine 506. The hypervisor-specific storage configuration defines parameters and settings that enable the virtualization system 504 to properly attach and utilize the virtual disk 508 created in the storage system 502. It may include details such as storage connection protocols, addressing information, authentication credentials, and/or any other parameters required for the virtualization system 504 to access and manage the virtual disk 508. The management platform 106 may generate this configuration using the same storage provider plugin 514 used to create the virtual disk 508, as the plugin has knowledge of both the normalized data model 512 and the specific details of its corresponding storage system 502. For example, storage provider plugin 514A may be used to both create the virtual disk 508 in storage system 502A and generate a configuration for the virtualization system 504 to enable virtual machine 506 to use the virtual disk 508 in storage system 502A. The storage provider plugin 514 may implement a method to generate the hypervisor-specific storage configuration. This method may take parameters from the normalized data model 512 and produce a configuration that the virtualization system 504 can understand and use. In some cases, this configuration may be in the form of a configuration file that specifies the storage connection details, protocols, and any other necessary parameters for the virtualization system 504 to access the virtual disk 508. The management platform 106 may then transmit this configuration file to the virtualization system 504 to configure the virtual machine’s storage access.

With the hypervisor-specific storage configuration generated, the management platform 106 may proceed to create the virtual machine 506 in the virtualization system 504. The creation process may involve specifying virtual hardware resources like CPU, memory, and network interfaces for the virtual machine 506. Additionally, the management platform 106 may configure any required virtualization settings and attach the virtual disk 508 to the virtual machine 506 using the hypervisor-specific storage configuration. The management platform 106 may use the generated configuration to ensure that the virtual machine 506 can properly access and use the virtual disk 508 created in the storage system 502A.

Optionally, a storage provider plugin 514 may implement a data store event mechanism to receive notifications about virtual machine movement and power state changes. This mechanism may allow the plugin to register as a listener for asynchronous events from the storage system 502. For example, if the virtual disk 508 is moved, the storage provider plugin 514 may receive a notification and take appropriate actions, such as adjusting storage access paths.

The management platform 106 may use the storage provider plugins 514 to handle various types of service requests from a user device 108. A service request may include instructions that call for the management platform 106 to execute a specified task.

If a service request from the user device 108 specifies direct creation of the virtual machine 506, the service request may specify templates for both the virtual machine 506 and the virtual disk 508. These templates may define default configurations and settings to streamline the provisioning process. The management platform 106 can use these templates to efficiently create and configure the virtual machine 506 and associated virtual disk 508 according to predefined specifications.

If a service request from the user device 108 specifies an application, the management platform 106 may proceed to deploy the application on the newly created virtual machine 506 based on a generated orchestration sequence. This may involve installing necessary software, configuring application settings, and establishing connections to other required services or resources. The management platform 106 may also configure policies and settings for the application based on the orchestration sequence, ensuring that the application is properly set up and optimized for the specific environment in which it is deployed. The normalized data model 512 may be used to generate orchestration sequences for applications. When a service request from the user device 108 specifies an application, the management platform 106 may use the normalized data model 512 to determine the required resources and dependencies for that application. This allows the management platform 106 to create an orchestration sequence that outlines the steps needed to deploy the application, including provisioning virtual machines, configuring storage, and setting up networking.

The management platform 106 may select the appropriate storage provider plugin 514 from a plurality of available plugins based on the requirements specified in the service request and the type of the storage system 502 being used. The requirements may be explicitly identified within the request itself or determined by a generated orchestration sequence. The selection process may utilize the normalized data model 512. The selection process may involve examining metadata associated with each plugin and matching it against the characteristics of the target storage system 502. By selecting the correct plugin, the management platform 106 may ensure that the appropriate provider-specific operations are used for each storage-related task.

The storage provider plugin architecture illustrated in FIG. 5 enables the management platform 106 to manage heterogeneous storage systems 502 through a unified interface. By using storage provider plugins 514 in conjunction with a normalized data model 512, the management platform 106 may create virtual disks 508, generate hypervisor-specific storage configurations for virtual machines 506, and manage the lifecycle of storage resources across diverse storage systems 502. This architecture provides flexibility and extensibility, allowing new storage systems 502 to be integrated into the management environment 100 without requiring changes to the core components of the management platform 106.

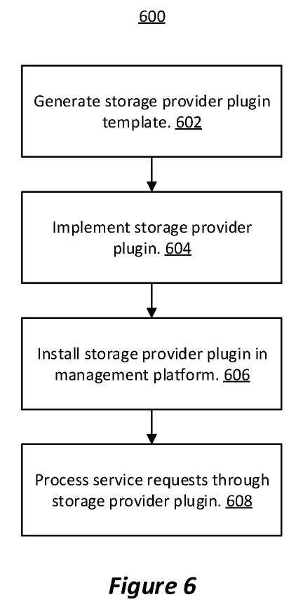

FIG. 6 is a flowchart of a method 600 for implementing a storage provider plugin, according to some implementations. The method 600 will be described in conjunction with the management environment 100 of FIG. 5. The method 600 may be used for implementing pluggable storage normalization, thus allowing the management platform 106 to utilize multiple types of storage systems 502. Specifically, the method 600 may be performed to create a new storage provider plugin 514 which enables the management platform 106 to interface with and manage a particular type of storage system 502 which it may not natively support.

At step 602, a storage provider plugin template is generated. The plugin template includes source code and build tooling, with the source code including predefined integration points for interacting with the storage system 502 using the normalized data model 512. The source code may implement interfaces (e.g., by inheriting from abstract classes) that correspond to operations which may be performed using the normalized data model 512. The build tooling may include scripts and configuration files necessary for compiling the source code into a binary executable. The template may be generated by the management platform 106 or obtained separately by a user (e.g., from a vendor of the management platform 106). In some cases, the management platform 106 may provide the plugin template to a user device 108, allowing developers to implement storage provider plugins for specific storage systems 502.

The plugin template may include a standardized interface for various storage-related operations. For example, the standardized interface may define methods for creating volumes, deleting volumes, cloning volumes, resizing volumes, preparing hosts for volume attachment, and releasing volumes from hosts. This standardized interface may ensure consistency across different storage provider implementations while allowing the interfaces to work as expected for the target storage system 502.

In some implementations, the plugin template may further include optional interfaces that represent additional functionalities that can be optionally implemented for the target storage system 502. A snapshot interface may allow a storage provider plugin 514 to implement snapshot-related operations if the target storage system 502 supports them. An events interface may allow a storage provider plugin 514 to register for and handle asynchronous notifications from the storage system 502, such as volume state changes or storage array alerts.

At step 604, the user implements the storage provider plugin 514 using the template. Using the plugin template provided by the management platform 106, the user may (via, e.g., their user device 108) write code to implement the desired interface(s) of the plugin template. At least the standardized interface (and potentially one or more optional interfaces) are implemented. The user-authored implementation may involve translating operations from the normalized data model 512 into programming interface calls specific to the target storage system 502 which is implemented. The user may implement methods for performing storage operations (such as cloning, resizing, or creating snapshots of virtual disks) at the storage system 502. Additionally, the user may implement functionality to register a listener for asynchronous events from the storage system 502.

During implementation, the user may need to consider the specific capabilities and limitations of the target storage system 502 for which they are authoring a plugin. For example, if implementing a plugin for an iSCSI-based storage array, the user may need to implement methods for managing LUN creation, iSCSI target configuration, and initiator group management. The implementation may also include logic for optimizing storage operations based on the unique features of the target storage system 502, such as thin provisioning, data deduplication, or storage tiering.

The management platform 106 may generate storage configurations specific to the virtualization system 504. Authoring these aspects of the storage provider plugin 514 may involve implementing XML specifications or other configuration formats that enable the virtualization system 504 to properly attach and utilize the storage resources provided by the storage system 502. Thus, the management platform 106 may translate generic parameters from the normalized data model 512 and provider-specific parameters from the storage system 502 into configuration parameters suitable for the virtualization system 504. The user may implement aspects of the storage provider plugin 514 that assist in obtaining provider-specific details needed as part of generating the configuration.

Once implementation by the user is complete, the user may use the provided build tooling to compile the source code into a binary executable. The binary executable may be packaged into the storage provider plugin 514.

At step 606, the storage provider plugin 514 is installed in the management platform 106. The management platform 106 may receive the storage provider plugin 514 from the user device 108. The received storage provider plugin 514 may include the binary executable compiled from the source code. The installation process may involve registering the storage provider plugin 514 with the management platform 106, which may include storing metadata about the plugin’s capabilities and the type of storage system 502 the plugin supports. The management platform 106 may validate the plugin to ensure the plugin correctly implements the required interfaces.

Optionally, the management platform 106 may perform compatibility checks to ensure that the plugin meets the required specifications and does not conflict with existing plugins or system components. The platform may also update its internal configurations to include information about the new plugin, such as the types of storage operations it supports and any specific features or limitations of the associated storage system 502.

At step 608, the management platform 106 processes service requests through the installed storage provider plugin 514. When a service request is received that involves operations on a storage system 502 supported by the installed storage provider plugin 514, the management platform 106 may dynamically load the storage provider plugin 514 at runtime. For example, the storage provider plugin 514 may be loaded through an isolated class loader, which allows the management platform 106 to use multiple plugins concurrently while maintaining separation between different plugin implementations. The management platform 106 may invoke storage operations of the storage provider plugin 514, such as cloning, resizing, or snapshot operations for virtual disks. The storage provider plugin 514 may translate generic data and/or storage requests from the normalized data model 512 into provider-specific programming interface calls for the target storage system 502.

When processing service requests, the management platform 106 may use the normalized data model 512 to determine the appropriate actions and sequence of operations. For instance, when creating a new virtual machine 506 that requires storage from a specific storage system 502, the management platform 106 may first use the relevant storage provider plugin 514 to create the necessary virtual disk 508. The storage provider plugin 514 may handle the intricacies of communicating with the storage system 502, such as invoking the appropriate programming interface calls to create a LUN or volume.

After creating the storage resources, the management platform 106 may use the storage provider plugin 514 to generate a hypervisor-specific storage configuration for accessing the target storage system 502. This configuration may be in the form of a configuration file (e.g., in XML or another format) that specifies how the virtualization system 504 should connect to and use the newly created storage resources. The storage provider plugin 514 may include logic to optimize this configuration based on the capabilities of the storage system 502. The management platform 106 transmits the configuration file to the virtualization system 504 to create the virtual machine 506.

Optionally, additional steps may also be performed. In some cases, the storage provider plugin 514 may be registered as a listener for asynchronous events from the storage system 502. This allows the management platform 106 to receive and process asynchronous event notifications from the storage system 502 through the storage provider plugin 514. For example, if a virtual machine 506 or a virtual disk 508 is moved, the storage system 502 may generate an event. The storage provider plugin 514, registered as a listener, may receive this event, allowing the management platform 106 to update the normalized data model 512 and take any necessary actions in response to the change.

The event handling capability may allow the management platform 106 to maintain an up-to-date view of the storage environment (e.g., in the normalized data model 512) and respond to changes in real-time. For instance, if a storage volume becomes unavailable or its performance characteristics change, the management platform 106 can be notified through the storage provider plugin 514, and may then take appropriate actions such as adjusting storage access paths or alerting administrators.

Throughout the lifecycle of storage resources, the storage provider plugin 514 may be used to manage various aspects of the storage system 502. This may include monitoring storage utilization, managing storage policies, and performing maintenance tasks such as storage migration or load balancing. The management platform 106 invokes storage operations of the storage provider plugin 514, such as cloning, resizing, or snapshot operations for a virtual disk 508. The plugin architecture allows these operations to be performed consistently across different storage systems 502, while still leveraging the unique capabilities of each storage system 502.

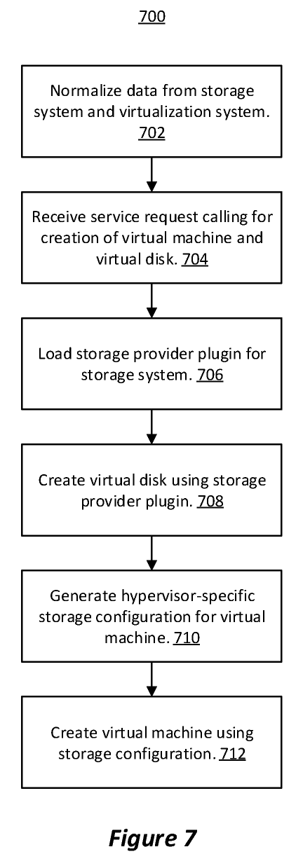

FIG. 7 illustrates a flowchart of a method 700 for creating a virtual machine and virtual disk, according to some implementations. The method 700 will be described in conjunction with the management environment 100 of FIG. 5. The method 700 may be performed by the management platform 106.

The management platform 106 may perform a step 702 of normalizing data from a storage system 502 and a virtualization system 504 into a normalized data model 512. This normalization process may involve transforming provider-specific storage attributes and operations into a standardized format that can be consistently used across different storage systems 502. The normalized data model 512 may provide a common representation for storage resources and operations, enabling the management platform 106 to interact with heterogeneous storage backends through a unified interface.

The management platform 106 may perform a step 704 of receiving a service request calling for creation of a virtual machine 506 in the virtualization system 504. The service request may further call for creation of a virtual disk 508 for the virtual machine 506 in a storage system 502. This request may originate from the user device 108 and may specify parameters for the desired resources. In cases where the service request directly requests creation of a virtual machine, the service request may specify a template for the virtual machine 506 and a template for the virtual disk 508, providing default configurations to streamline the provisioning process. In cases where the service request specifies an application for orchestration rather than direct creation of a virtual machine, the management platform 106 may generate an orchestration sequence for the application based on the normalized data model 512. This orchestration sequence may include a process for automated creation of the virtual machine 506 and the virtual disk 508, as well as additional steps for deploying the application on the virtual machine 506 and configuring policies and settings based on the orchestration sequence.

The management platform 106 may perform a step 706 of loading a storage provider plugin 514 for the storage system 502. The management platform 106 may select the appropriate storage provider plugin 514 from a plurality of storage provider plugins based on the type of the storage system 502 specified (directly or indirectly) in the service request. In some cases, the storage provider plugin 514 may be loaded dynamically at runtime through an isolated class loader, allowing the management platform 106 to use multiple plugins concurrently while maintaining separation between different plugin implementations.

The management platform 106 may perform a step 708 of creating the virtual disk 508 in the storage system 502 using the storage provider plugin 514. The storage provider plugin 514 may normalize interactions between the normalized data model 512 and the storage system 502, translating generic storage requests from the normalized data model 512 into provider-specific programming interface calls for the target storage system 502. This may involve allocating storage space and initializing the disk structure according to the specified parameters.

The management platform 106 may perform a step 710 of generating a hypervisor-specific storage configuration for the virtual machine 506 using the storage provider plugin 514. This configuration may specify parameters for attaching the virtual disk 508 from the storage system 502 to the virtual machine 506 in a format compatible with the virtualization system 504. The hypervisor-specific storage configuration may be a configuration file. In some cases, the hypervisor-specific storage configuration may be an Extensible Markup Language (XML) file that includes details such as storage connection protocols, addressing information, and authentication credentials required for the virtualization system 504 to access and manage the virtual disk 508.

The management platform 106 may perform a step 712 of creating the virtual machine 506 in the virtualization system 504 using the hypervisor-specific storage configuration. This may involve specifying virtual hardware resources for the virtual machine 506 and attaching the virtual disk 508 to the virtual machine 506 using the generated configuration. In some cases, the management platform 106 may transmit the XML file to the virtualization system 504 to configure the virtual machine’s storage access.

Optionally, after creating the virtual machine 506 and virtual disk 508, the management platform 106 may perform additional operations using the storage provider plugin 514. In some implementations, the management platform 106 may invoke a storage operation, such as a cloning operation, a resizing operation, a snapshot operation, or the like for the virtual disk 508. These operations may be executed through the standardized interface provided by the storage provider plugin 514, which translates the requests into provider-specific actions for the storage system 502. In some implementations, the management platform 106 may register the storage provider plugin 514 as a listener for asynchronous events from the storage system 502. This allows the management platform 106 to receive and process an asynchronous event notification, such as notifications of changes in the location of a virtual disk 508, notifications of changes in the location or power state of a virtual machine 506, or the like. For example, if the virtual disk 508 is moved, the storage provider plugin 514 may receive a notification, allowing the management platform 106 to take appropriate actions, such as adjusting storage access paths.

The pluggable storage normalization architecture may be used for orchestrating and managing heterogeneous storage systems across multiple cloud environments. By utilizing a modular architecture with a normalized data model and storage provider plugins, the system enables seamless integration of various storage protocols and formats through a unified platform. This approach offers several advantages, including simplified management of diverse storage systems, enhanced compatibility across different virtualization platforms, and improved flexibility in integrating new storage providers. The system’s ability to generate hypervisor-specific storage configurations and handle complex orchestration sequences further streamlines the deployment and management of virtual machines and applications in multi-cloud environments, ultimately reducing operational overhead and enhancing an organization’s ability to leverage diverse cloud storage technologies.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Any suitable operation or sequence of operations described or illustrated herein may be interrupted, suspended, or otherwise controlled by another process, such as an operating system or kernel, where appropriate. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. It is therefore intended that the appended claims encompass any such modifications or implementations.

What is claimed is:

1. A computer-implemented method comprising:
normalizing data from a storage system and a virtualization system into a normalized data model;
receiving a service request calling for creation of a virtual machine in the virtualization system, the service request further calling for creation of a virtual disk for the virtual machine in the storage system;
loading a storage provider plugin for the storage system;
creating the virtual disk in the storage system using the storage provider plugin, wherein the storage provider plugin normalizes interactions between the normalized data model and the storage system;
generating a hypervisor-specific storage configuration for the virtual machine using the storage provider plugin, wherein the hypervisor-specific storage configuration specifies parameters for attaching the virtual disk from the storage system to the virtual machine in a format compatible with the virtualization system; and
creating the virtual machine in the virtualization system using the hypervisor-specific storage configuration.

2. The method of claim 1, wherein loading the storage provider plugin comprises:
selecting the storage provider plugin from a plurality of storage provider plugins based on a type of the storage system; and
loading the storage provider plugin dynamically at runtime through an isolated class loader.

3. The method of claim 1, further comprising generating the storage provider plugin by:
providing a plugin template to a user device, the plugin template comprising source code and build tooling, the source code comprising predefined integration points for interacting with the storage system using the normalized data model; and
receiving the storage provider plugin from the user device, the storage provider plugin comprising a binary executable compiled from the source code using the build tooling.

4. The method of claim 1, further comprising:
invoking a storage operation of the storage provider plugin, the storage operation comprising a cloning operation, a resizing operation, or a snapshot operation for the virtual disk.

5. The method of claim 1, wherein the hypervisor-specific storage configuration is an Extensible Markup Language (XML) file, and creating the virtual machine comprises:
transmitting the XML file to the virtualization system.

6. The method of claim 1, further comprising:
registering the storage provider plugin as a listener for asynchronous events from the storage system;
receiving an asynchronous event notification from the storage system using the storage provider plugin; and
processing the asynchronous event notification using the storage provider plugin.

7. The method of claim 1, wherein the service request specifies a template for the virtual machine and a template for the virtual disk.

8. The method of claim 1, wherein the service request specifies an application, and the method further comprises:
generating an orchestration sequence for the application based on the normalized data model, wherein the orchestration sequence comprises a process for automated creation of the virtual machine and the virtual disk;
deploying the application on the virtual machine based on the orchestration sequence; and
configuring policies and settings of the application based on the orchestration sequence.

9. A system comprising:
a storage system;
a virtualization system;
a management server configured to:
normalize data from the storage system and the virtualization system into a normalized data model;
receive a service request calling for creation of a virtual machine in the virtualization system, the service request further calling for creation of a virtual disk for the virtual machine in the storage system;
load a storage provider plugin for the storage system;
create the virtual disk in the storage system using the storage provider plugin, wherein the storage provider plugin normalizes interactions between the normalized data model and the storage system;
generate a hypervisor-specific storage configuration for the virtual machine using the storage provider plugin, wherein the hypervisor-specific storage configuration specifies parameters for attaching the virtual disk from the storage system to the virtual machine in a format compatible with the virtualization system; and
create the virtual machine in the virtualization system using the hypervisor-specific storage configuration.

10. The system of claim 9, wherein, to load the storage provider plugin, the management server is configured to:
select the storage provider plugin from a plurality of storage provider plugins based on a type of the storage system; and
load the storage provider plugin dynamically at runtime through an isolated class loader.

11. The system of claim 9, wherein the management server is further configured to generate the storage provider plugin by:
providing a plugin template to a user device, the plugin template comprising source code and build tooling, the source code comprising predefined integration points for interacting with the storage system using the normalized data model; and
receiving the storage provider plugin from the user device, the storage provider plugin comprising a binary executable compiled from the source code using the build tooling.

12. The system of claim 9, wherein the management server is further configured to:
invoke a storage operation of the storage provider plugin, the storage operation comprising a cloning operation, a resizing operation, or a snapshot operation for the virtual disk.

13. The system of claim 9, wherein the hypervisor-specific storage configuration is an Extensible Markup Language (XML) file, and, to create the virtual machine, the management server is configured to:
transmit the XML file to the virtualization system.

14. The system of claim 9, wherein the management server is further configured to:
register the storage provider plugin as a listener for asynchronous events from the storage system;
receive an asynchronous event notification from the storage system using the storage provider plugin; and
process the asynchronous event notification using the storage provider plugin.

15. The system of claim 9, wherein the service request specifies a template for the virtual machine and a template for the virtual disk.

16. The system of claim 9, wherein the service request specifies an application, and the management server is further configured to:
generate an orchestration sequence for the application based on the normalized data model, wherein the orchestration sequence comprises a process for automated creation of the virtual machine and the virtual disk;
deploy the application on the virtual machine based on the orchestration sequence; and
configure policies and settings of the application based on the orchestration sequence.

17. A device comprising:
a processor; and
a non-transitory computer-readable medium storing instructions which, when executed by the processor, cause the processor to:
normalize data from a storage system and a virtualization system into a normalized data model;
receive a service request calling for creation of a virtual machine in the virtualization system, the service request further calling for creation of a virtual disk for the virtual machine in the storage system;
load a storage provider plugin for the storage system;
create the virtual disk in the storage system using the storage provider plugin, wherein the storage provider plugin normalizes interactions between the normalized data model and the storage system;
generate a hypervisor-specific storage configuration for the virtual machine using the storage provider plugin, wherein the hypervisor-specific storage configuration specifies parameters for attaching the virtual disk from the storage system to the virtual machine in a format compatible with the virtualization system; and
create the virtual machine in the virtualization system using the hypervisor-specific storage configuration.

18. The device of claim 17, wherein the instructions further cause the processor to:
select the storage provider plugin from a plurality of storage provider plugins based on a type of the storage system; and
load the storage provider plugin dynamically at runtime through an isolated class loader.

19. The device of claim 17, wherein the instructions further cause the processor to:
invoke a storage operation of the storage provider plugin, the storage operation comprising a cloning operation, a resizing operation, or a snapshot operation for the virtual disk.

20. The device of claim 17, wherein the instructions further cause the processor to:
register the storage provider plugin as a listener for asynchronous events from the storage system;
receive an asynchronous event notification from the storage system using the storage provider plugin; and
process the asynchronous event notification using the storage provider plugin.
